(19) United States
(12) Patent Application Publication
(10) Pub. No.: US 2025/0258656 A1
(43) Pub. Date: Aug. 14, 2025

(54) DATA PROCESSING SYSTEM AND DATA PROCESSING METHOD

(71) Applicant: Semiconductor Energy Laboratory Co., Ltd., Atsugi-shi (JP)

(72) Inventors: Naoaki TSUTSUI, Atsugi (JP); Ryo NAKAZATO, Ebina (JP)

(21) Appl. No.: 19/038,841

(22) Filed: Jan. 28, 2025

(30) Foreign Application Priority Data
Feb. 8, 2024 (JP) 2024-017712

(51) Int. Cl. G06F 8/30; G06F 16/332

(52) U.S. Cl. CPC G06F 8/30; G06F 16/332

(57) ABSTRACT

A novel data processing system that is convenient, useful, or reliable is provided. The data processing system includes a first component, a second component, and a third component. The first component receives an idea from a user and transmits the idea to the second component. The second component receives the idea, creates a prompt, and transmits the prompt to the third component. The third component receives the prompt, generates a first code snippet with use of a large language model, and transmits the first code snippet to the second component. The second component receives the first code snippet, creates a query, searches out a related code snippet with use of a search engine, creates a suggestion, and transmits the suggestion to the first component. The first component receives the suggestion and provide the suggestion to the user.

### BACKGROUND OF THE INVENTION

### 1. Field of the Invention

One embodiment of the present invention relates to a data processing system, a data processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specifically, examples of the technical field of one embodiment of the present invention disclosed in this specification include a data processing device, a semiconductor device, a storage device, a method for driving any of them, and a method for manufacturing any of them.

### 2. Description of the Related Art

In recent years, language models using neural networks have been actively developed, and especially large language models (LLM) have attracted attention. A large language model is a natural language processing model in which learning is performed using a massive amount of data. With a large language model, for example, a conversational model that gives an answer to a user's instruction can be achieved. In Non-Patent Document 1, generative pre-trained transformer 4 (GPT-4, registered trademark) is disclosed as a large language model, and ChatGPT is disclosed as a conversational model.

By utilizing a large language model, the capacity of a natural language processing model is significantly increased. On the other hand, it is difficult to incorporate and operate a language model at one's own facilities and expense due to the expansion of the language model. Accordingly, a language model provided by an external service is generally used.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

An object of one embodiment of the present invention is to provide a novel data processing system that is highly convenient, useful, or reliable. Another object is to provide a novel data processing method that is highly convenient, useful, or reliable. Another object is to provide a novel data processing system, a novel data processing method, or a novel semiconductor device.

Note that the description of these objects does not preclude the existence of other objects. In one embodiment of the present invention, there is no need to achieve all of these objects. Other objects will be apparent from and can be derived from the description of the specification, the drawings, the claims, and the like.

(1) One embodiment of the present invention is a data processing system including a first component, a second component, and a third component.

The first component has a function of receiving an idea and transmitting the idea to the third component and a function of receiving a first suggestion and providing the first suggestion.

The second component has a function of receiving a prompt, performing processing with a large language model, and transmitting a first code snippet to the third component. The large language model has a function of generating the first code snippet in accordance with the prompt.

The third component includes a first subcomponent, a second subcomponent, a third subcomponent.

The first subcomponent has a function of receiving the idea, creating the prompt, and transmitting the prompt to the second component. Note that the prompt includes the idea and an instruction for generating the first code snippet from the idea.

The second subcomponent has a function of receiving the first code snippet and creating a query and includes a search engine and an index. The query includes the first code snippet.

The search engine has a function of searching out a related code snippet related to the query with use of the index and a function of calculating a similarity. The index includes a document, and the document includes a second code snippet.

The related code snippet includes the second code snippet. The similarity represents a degree of correlation between the first code snippet and the second code snippet.

The third subcomponent has a function of receiving the related code snippet, creating the first suggestion, and transmitting the first suggestion to the first component. Note that the first suggestion includes the related code snippet.

Thus, the first code snippet can be generated from an idea written in a natural language in a text editor by a user, for example. A composition of one or both of a function and specifications of an integrated circuit written in a natural language by the user can be used for the idea, for example. Furthermore, on the basis of the idea, the first code snippet where a register transfer level (RTL) of the integrated circuit is written in a hardware description language can be generated, for example.

The second code snippet related to the first code snippet generated from the idea can be searched out with use of the index. In addition, design assets can be stored in the index, for example. Note that the details of the design assets will be described later. The second code snippet related to the first code snippet can be searched out from the design assets, for example.

One or more code snippets related to the first code snippet can be used for the related code snippet. The related code snippet can be written in the first suggestion and provided for the user. The code snippet that has been assessed can be searched out from the design assets and provided for the user. As a result, a novel data processing system that is highly convenient, useful, or reliable can be provided.

(2) Another embodiment of the present invention is the data processing system in which the first component has a function of receiving design information and transmitting the design information to the third component.

The second subcomponent has a function of receiving the design information and the first code snippet and creating a query. Note that the query includes the design information and the first code snippet.

Thus, the design information can be included in conditions for searching out the related code snippet with use of the index. Furthermore, for example, an operating frequency can be included in the conditions for searching out the related code snippet with use of the index. Furthermore, for example, power consumption can be included in the conditions for searching out the related code snippet with use of the index. As a result, a novel data processing system that is highly convenient, useful, or reliable can be provided.

(3) Another embodiment of the present invention is the data processing system in which the first component has a function of receiving selected information, adopting the second code snippet from the first suggestion, and adding the second code snippet after the idea.

Thus, a plurality of code snippets can be provided to the user, for example. Furthermore, one selected from the related code snippets can be added after the idea written in the text editor, for example. As a result, a novel data processing system that is highly convenient, useful, or reliable can be provided.

(4) Another embodiment of the present invention is the data processing system in which the first component has a function of receiving an incomplete code and transmitting the incomplete code to the third component. The first component has a function of receiving a second suggestion and providing the second suggestion.

The second component has a function of receiving the incomplete code, generating a third code snippet, and transmitting the third code snippet to the third component.

The first subcomponent has a function of receiving the incomplete code and transmitting the incomplete code to the second component. The third subcomponent has a function of receiving the third code snippet, creating the second suggestion, and transmitting the second suggestion to the first component. Note that the second suggestion includes the third code snippet.

Thus, the third code snippet can be generated with use of the large language model, so that a complement to the incomplete code can be suggested. Furthermore, without referring to the design assets, the third code snippet can be generated with use of the large language model, so that a complement to the incomplete code can be suggested. As a result, a novel data processing system that is highly convenient, useful, or reliable can be provided.

(5) Another embodiment of the present invention is a data processing method including a first step, a second step, a third step, a fourth step, a fifth step, a sixth step, a seventh step, an eighth step, and a ninth step.

In the first step, a first component receives an idea and transmits the idea to a second component.

In the second step, the second component receives the idea and creates a prompt. Note that the prompt includes the idea and an instruction for generating a first code snippet from the idea.

In the third step, the second component transmits the prompt to a third component.

In the fourth step, the third component receives the prompt and generates the first code snippet with use of a large language model. The large language model has a function of generating the first code snippet in accordance with the prompt.

In the fifth step, the third component transmits the first code snippet to the second component.

In the sixth step, the second component receives the first code snippet and creates a query. The query includes the first code snippet.

In the seventh step, the second component searched out a related code snippet using a search engine. The second component includes the search engine and an index.

The search engine has a function of searching out a related code snippet related to the query with use of the index and a function of calculating a similarity. The index includes a document, and the document includes a second code snippet.

The related code snippet includes the second code snippet. The similarity represents a degree of correlation between the first code snippet and the second code snippet.

In the eighth step, the second component creates a suggestion and transmits the suggestion to the first component. The suggestion includes the related code snippet.

In the ninth step, the first component receives and provides the suggestion.

Thus, the first code snippet can be generated from the idea written in a natural language in a text editor by a user, for example. A composition of one or both of a function and specifications of an integrated circuit written in a natural language by the user can be used for the idea, for example. Furthermore, on the basis of the idea, the first code snippet where a register transfer level of the integrated circuit is written in a hardware description language can be generated, for example.

The second code snippet related to the first code snippet generated from the idea can be searched out with use of the index. In addition, design assets can be stored in the index, for example. The second code snippet related to the first code snippet can be searched out from the design assets, for example.

One or more code snippets related to the first code snippet can be used for the related code snippet. The related code snippet can be written in the suggestion and provided for the user. The code snippet that has been assessed can be searched out from the design assets and provided for the user. As a result, a novel data processing method that is highly convenient, useful, or reliable can be provided.

(6) Another embodiment of the present invention is the data processing method including the first step, the second step, the third step, the fourth step, the fifth step, the sixth step, the seventh step, the eighth step, and the ninth step.

In the first step, the first component receives design information and the idea and transmits the design information and the idea to the second component.

In the sixth step, the second component receives the design information and the first code snippet to create a query. Note that the query includes design information and the first code snippet.

Thus, the design information can be included in conditions for searching out the related code snippet with use of the index. Furthermore, for example, an operating frequency can be included in the conditions for searching out the related code snippet with use of the index. Furthermore, for example, power consumption can be included in the conditions for searching out the related code snippet with use of the index. As a result, a novel data processing method that is highly convenient, useful, or reliable can be provided.

(7) Another embodiment of the present invention is the data processing method including the first step, the second step, the third step, the fourth step, the fifth step, the sixth step, the seventh step, the eighth step, the ninth step, a tenth step, and an eleventh step.

In the tenth step following the ninth step, the first component receives selected information and adopts the second code snippet from the suggestion.

In the eleventh step, the first component adds the second code snippets after the idea.

Thus, a plurality of code snippets can be provided to a user, for example. Furthermore, one selected from the related code snippets can be added after the idea written in the text editor, for example. As a result, a novel data processing method that is highly convenient, useful, or reliable can be provided.

One embodiment of the present invention can provide a novel data processing system that is highly convenient, useful, or reliable. Alternatively, a novel data processing method that is highly convenient, useful, or reliable can be provided. Alternatively, a novel data processing system, a novel data processing method, or a novel semiconductor device can be provided.

Note that the description of these effects does not preclude the existence of other effects. One embodiment of the present invention does not necessarily have all of these effects. Other effects will be apparent from and can be derived from the description of the specification, the drawings, the claims, and the like.

### BRIEF DESCRIPTION OF THE DRAWINGS

In the accompanying drawings:

FIG. 1 illustrates a structure of a data processing system of an embodiment;

FIG. 2 illustrates a structure of a component used in a data processing system of an embodiment;

FIGS. 3A to 3C illustrate structures of a prompt and queries used in a data processing system of an embodiment;

FIGS. 4A and 4B illustrate structures of an index and a related code snippet used in a data processing system of an embodiment;

FIG. 5 illustrates a structure of a suggestion provided by a data processing system of an embodiment;

FIG. 6 illustrates a structure of a suggestion provided by a data processing system of an embodiment;

FIG. 7 illustrates a structure of a data processing device used for a data processing system of an embodiment;

FIG. 8 illustrates a data processing method of an embodiment; and

FIG. 9 illustrates a data processing method of an embodiment.

### DETAILED DESCRIPTION OF THE INVENTION

The data processing system of one embodiment of the present invention includes a first component, a second component, and a third component. The first component has a function of receiving an idea and transmitting the idea to the third component and a function of receiving a first suggestion and providing the first suggestion. The second component has a function of receiving a prompt and performing processing with a large language model and a function of transmitting a first code snippet to the third component. The large language model has a function of generating the first code snippet in accordance with the prompt.

The third component includes a first subcomponent, a second subcomponent, and a third subcomponent.

The first subcomponent has a function of receiving the idea, creating the prompt and transmitting the prompt to the second component. Note that the prompt includes the idea and an instruction for generating the first code snippet from the idea.

The second subcomponent has a function of receiving the first code snippet and creating a query, and includes a search engine and an index. The query includes the first code snippet. The search engine has a function of searching out a related code snippet related to the query with use of the index and a function of calculating a similarity. The index includes a document, and the document includes a second code snippet. The related code snippet includes the second code snippet, and the similarity represents a degree of correlation between the first code snippet and the second code snippet.

The third subcomponent has a function of receiving the related code snippet and creating the first suggestion and a function of transmitting the first suggestion to the first component. Note that the first suggestion includes the related code snippet.

Thus, the first code snippet can be generated from an idea written in a natural language in a text editor by a user, for example. A composition of one or both of a function and specifications of an integrated circuit written in a natural language by the user can be used for the idea, for example. Furthermore, on the basis of the idea, the first code snippet where a register transfer level of the integrated circuit is written in a hardware description language can be generated, for example.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Although the block diagram in drawings attached to this specification shows components classified based on their functions in independent blocks, it is difficult to classify actual components based on their functions completely, and one component can have a plurality of functions.

### Embodiment 1

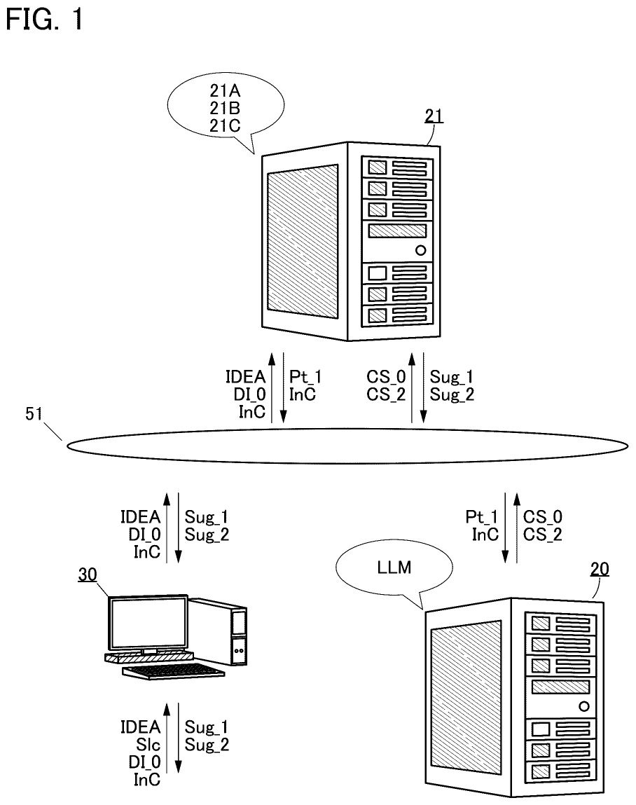

In this embodiment, a data processing system of one embodiment of the present invention will be described with reference to FIG. 1 to FIG. 7.

FIG. 1 illustrates a structure of the data processing system of one embodiment of the present invention.

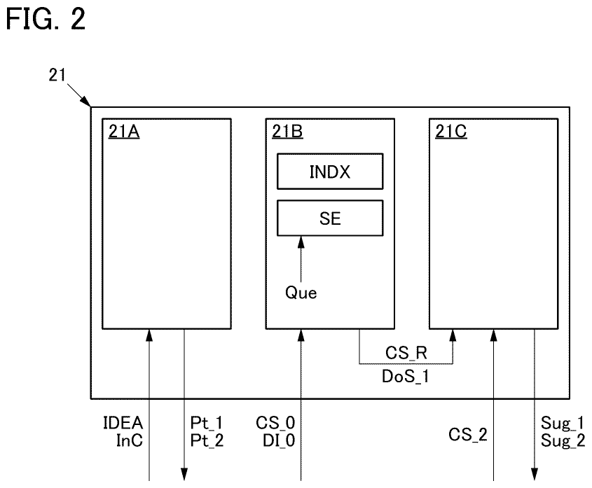

FIG. 2 illustrates a structure of a component in the data processing system of one embodiment of the present invention.

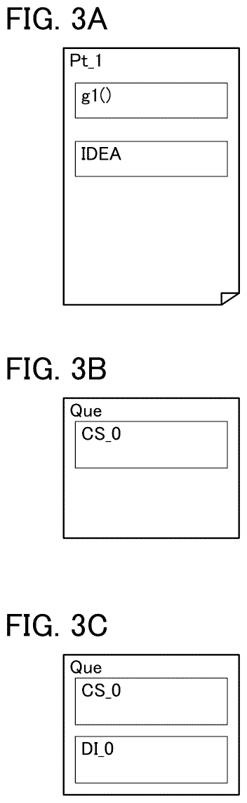

FIG. 3A is a schematic diagram illustrating a structure of a prompt used by the data processing system of one embodiment of the present invention, and FIGS. 3B and 3C are each a schematic diagram illustrating a structure of a query.

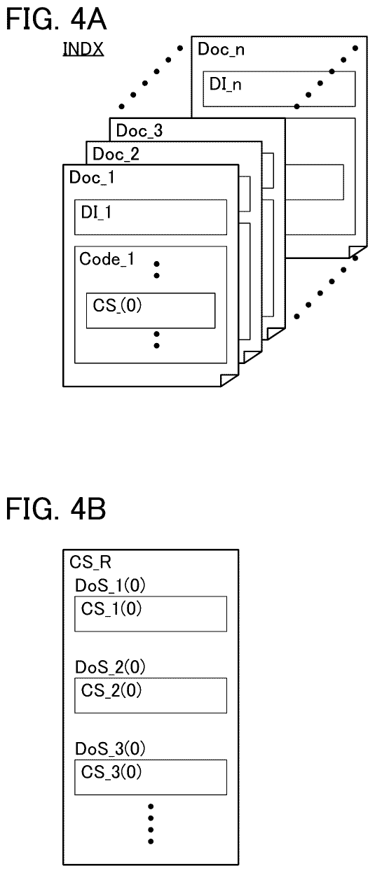

FIG. 4A is a schematic diagram illustrating a structure of an index provided by the data processing system of one embodiment of the present invention, and FIG. 4B is a schematic diagram illustrating a structure of a related code snippet.

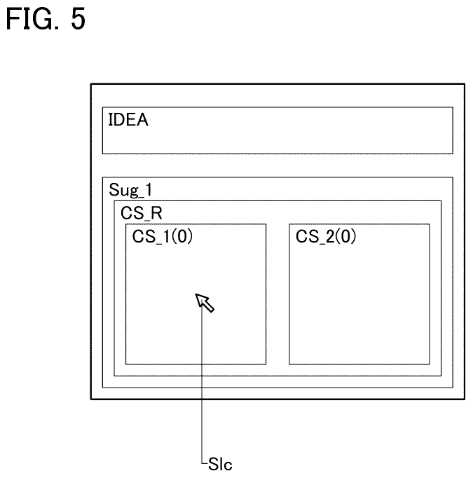

FIG. 5 is a schematic diagram illustrating a structure of a suggestion provided by the data processing system of one embodiment of the present invention.

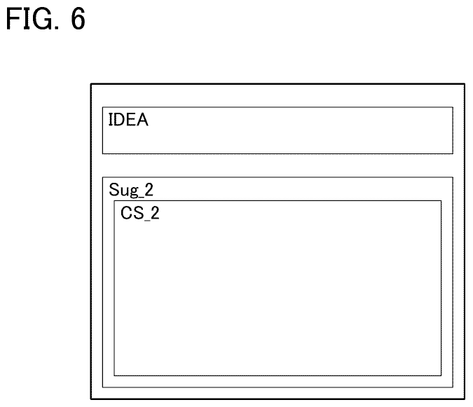

FIG. 6 is a schematic diagram illustrating a structure of a suggestion provided by the data processing system of one embodiment of the present invention.

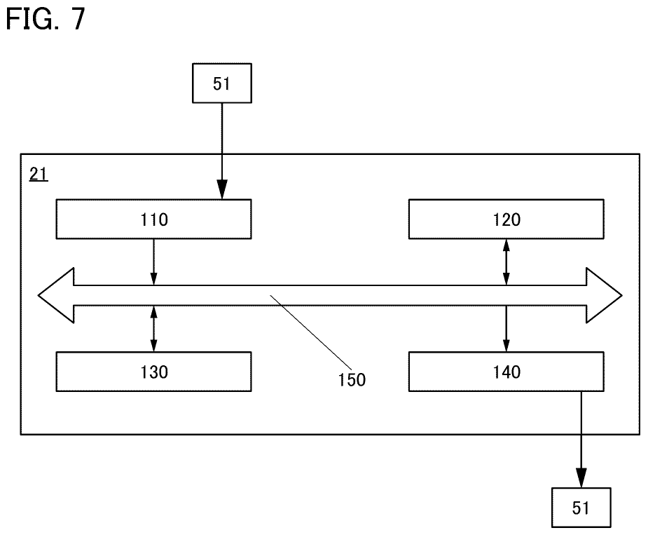

FIG. 7 is a block diagram illustrating a structure of a data processing device which can be used for the data processing system of one embodiment of the present invention.

### Structure Example 1 of Data Processing System

The data processing system of one embodiment of the present invention, which is described in this embodiment, includes a component 30, a component 20, and a component 21 (see FIG. 1).

### Structure Example 1 of Component 30

The component 30 has, for example, a function of receiving an idea (represented as IDEA in the drawings) from a user of the data processing system and transmitting the idea to the component 21, and a function of receiving a suggestion Sug_1 from the component 21 and providing the suggestion to the user via an output device such as a display device, a speaker, a printer, or a storage device. Furthermore, the user can input the idea to a text editor with use of an input device such as a keyboard, a pointing device, an eye-gaze input device, or a microphone. Specifically, the idea can be input into a code that is being created in a predetermined format. Specifically, the user inputs the idea to the component 30 with use of an input device such as a keyboard, a pointing device, or an eye-gaze input device. For example, a character string whose format begins with “//” can be used for comment text. Furthermore, a character string in a comment text format can be used for the idea. Specifically, the character string in the comment text format shown in the next paragraph expresses the idea on an 8-bit counter with reset signal in a natural language. Note that “clk” and “rst” each represent an input signal, and “value” represents an output signal.
“// 8-bit counter with reset
// input: clk, rst
// output: value”

### Structure Example 1 of Component 20

The component 20 has a function of receiving a prompt Pt_1, performing processing with use of a large language model LLM, and transmitting a code snippet CS_0 to the component 21.

The large language model LLM has a function of generating the code snippet CS_0 in accordance with the prompt Pt_1. For example, the large language model LLM that can be used for the component 20 is such a large language model that has learned a programming language such as Python or a hardware description language such as VHDL, Verilog, or System Verilog. Furthermore, the large language model LLM that has learned an electronic system level (ESL) language such as System C or C++ can be used for the component 20.

The code snippet includes one or more sentences (also referred to as statements). For example, a segment of a code can be used for the code snippet. Specifically, expressions that are often used in the code and fixed expressions can be used as the code snippet. The next paragraph shows an example of a segment of a code where a register transfer level of an integrated circuit is written with use of a hardware description language. This code snippet CS_0 written with Verilog expresses the 8-bit counter with a reset signal.

```
“module counter (
  input clk,
  input rest,
  output reg [7:0] value
):”
```

For example, as the large language model LLM, a language model such as GPT-3, GPT-3.5, GPT-4 (registered trademark), Language Model for Dialogue Applications (LaMDA), Llama2, or Codellama can be used.

### Structure Example of Component 21

The component 21 includes a subcomponent 21A, a subcomponent 21B, and a subcomponent 21C (see FIG. 2).

### Structure Example 1 of Subcomponent 21A

The subcomponent 21A has a function of receiving the idea, creating the prompt Pt_1, and transmitting the prompt Pt_1 to the component 20 (see FIG. 2). The prompt Pt_1 includes the idea and an instruction g1( ) for generating the code snippet CS_0 from the idea (see FIG. 3A). For example, the prompt Pt_1 specifies a language used for writing the code and instructs the generation of the code. Specifically, the sentence shown in the next paragraph can be used as the prompt Pt_1.

“Write a module meeting the following function or specification in Verilog.
// 8-bit counter with reset
// input: clk, rst
// output: value”

### Structure Example 1 of Subcomponent 21B

The subcomponent 21B has a function of receiving the code snippet CS_0 and creating a query Que, and includes a search engine SE and an index INDX (see FIG. 2). Note that the query Que includes the code snippet CS_0 (see FIG. 3B).

The search engine SE has a function of searching out a related code snippet CS_R related to the query Que with use of the index INDX and a function of calculating a similarity DoS_1.

The index INDX includes documents Doc_1 to Doc_n (see FIG. 4A). The document Doc_1 includes a code (represented as Code_1 in FIG. 4A), and the code includes a code snippet CS_1(0). The document Doc_1 includes design information DI_1, for example.

Note that the related code snippet CS_R includes the code snippet CS_1(0) (see FIG. 4B). A plurality of code snippets related to the code snippet CS_0 can be searched out from a plurality of document and adopted as the related code snippet CS_R. For example, the code snippet CS_1(0), a code snippet CS_2(0), and a code snippet CS_3(0) can be searched out from the document Doc_1, the document Doc_2, and the document Doc_3, respectively and adopted as the related code snippet CS_R.

A similarity DoS_1(0) represents the degree of correlation between the code snippet CS_0 and a code snippet CS_1. For example, a similarity DoS_2(0) represents a degree of correlation between the code snippet CS_0 and the code snippet CS_2(0), and a similarity DoS_3(0) represents a degree of correlation between the code snippet CS_0 and the code snippet CS_3(0).

For example, a full-text search system can be used as the subcomponent 21B. The full-text search system can create the index INDX of materials stored in an archive. Specifically, the index INDX of design assets stored in the archive can be created. Note that design assets include, for example, software IP, firmware IP, and hardware IP of a large-scale integrated circuit. In addition, the design assets include the kind of the hardware description language, the version of the hardware description language, a library which a language used in writing dependents on, license information, author information, the computational amount information representing the computational complexity, and the like.

For the archive of the materials, for example, an archive of official documents, an archive of private documents, an archive for managing confidential information of an organization to which a user of the data processing system belongs, and the like can be used. Specifically, past technological assets, design assets, publications of patent application, patent gazettes, books, literatures, handbooks, confidential documents, restricted confidential documents, and the like can be included as a search target. Note that the technological assets accumulated in the organization to which the user belongs are added to the archive, whereby featured information utilized in the organization can be shared with other users.

The full-text search system enables searching out information related to the query Que from the materials stored in the archive with use of the index INDX. Note that since the query Que includes the code snippet CS_0, a reserved word or the like of the programming language can be used as the search term.

For example, the materials stored in the archive can be segmented into words, and an inverted index that associates the word with the material where the word appears can be created. The inverted index can be used for the index INDX. Alternatively, an N-gram method in which the materials are divided by consecutive n characters can be used to create the inverted index. Specifically, character strings each including two characters, for example, are sequentially cut out from the materials, and then the character string can be associated with the material where the character string appears, whereby the inverted index can be created. The inverted index can be used for the index INDX. Note that the query Que can also be segmented into words, and the word can be used as a search term. Alternatively, the query Que can also be divided into character strings each including two characters, for example, and the character string can be used as a search term.

For example, the materials stored in the archive can be converted into distributed representations (also referred to as embedded representations) with use of a large language model. The distributed representation can be included in the index INDX. In addition, the query Que can also be converted into distributed representations with use of a large language model. Note that with use of distributed representation, not only documents written in different languages but also different types of data can be treated as related information. Specifically, image data, audio data, and video data can also be treated as related information of text data.

Specifically, the materials stored in the archive and the query Que can be converted into distributed representations using GPT-3, GPT-3.5, GPT-4 (registered trademark), LaMDA, Llama2, Codellama, and the like.

Comparing the distributed representations of the materials stored in the archive and the distributed representations of the query Que enables the semantic similarity to be found. Since the proximity between the meaning of the material stored in the archive and the meaning of the query Que can be evaluated, inconsistencies in expressions due to synonyms and the like can be ignored. In particular, inconsistencies in verb expressions in natural languages can be ignored.

For example, codes shown in the following two paragraphs are each a code “displaying 1 to 5” written in a programming language “python” and are similar to each other in semantics.

```
“# How to write 1
for i in range (5):
  print (i)”
“# How to write 2
i = 0
while True:
  print (i)
  i + = 1
  if i > 5:
    break”
```

For example, the similarity DoS_1 can be calculated using the Euclidean distance of the distributed representations to be compared. Furthermore, the cosine similarity of the distributed representations to be compared can be used as the similarity DoS_1.

### Structure Example 1 of Subcomponent 21C

The subcomponent 21C has a function of receiving the related code snippet CS_R, creating the suggestion Sug_1, and transmitting the suggestion Sug_1 to the component 30. The suggestion Sug_1 includes the related code snippet CS_R (see FIG. 5).

Thus, the code snippet CS_0 can be generated from the idea written in a natural language in the text editor by the user, for example. Furthermore, a composition of one or both of a function and specifications of an integrated circuit written in a natural language by the user can be used for the idea, for example. Furthermore, on the basis of the idea, the code snippet CS_0 where a register transfer level of the integrated circuit is written in a hardware description language can be generated, for example.

Moreover, the code snippet CS_1(0) related to the code snippet CS_0 generated from the idea can be searched out with use of the index INDX. In addition, design assets can be stored in the index INDX, for example. The code snippet CS_1(0) related to the code snippet CS_0 can be searched out from the design assets, for example.

Furthermore, one or more code snippets related to the code snippet CS_0 can be used as the related code snippet CS_R. The related code snippet CS_R can be written in the suggestion Sug_1 and provided to the user. In addition, a code snippet that has been assessed can be searched out from the design assets and provided for the user. As a result, a novel data processing system that is highly convenient, useful, or reliable can be provided.

### Structure Example 2 of Component 30

The component 30 has a function of receiving design information DI_0 from the user and transmitting the design information DI_0 to the component 21.

### Structure Example 2 of Subcomponent 21B

The subcomponent 21B has a function of receiving the design information DI_0 and the code snippet CS_0 and creating the query Que. The query Que includes the design information DI_0 and the code snippet CS_0 (see FIG. 3C). For example, the user can input information such as a function of a circuit, an area of a circuit, a latency, or a design rule as the design information DI_0 when the creation the code begins.

Thus, the design information DI_0 can be included in conditions for searching out the related code snippet CS_R with use of the index INDX. In addition, an operating frequency can be included in the conditions for searching out the related code snippet CS_R with use of the index INDX, for example. Furthermore, power consumption can be included in the conditions for searching out the related code snippet CS_R with use of the index INDX, for example. Furthermore, including the design information DI_0 in the searching conditions enables extremely valuable information to be extracted from the past technological assets. As a result, a novel data processing system that is highly convenient, useful, or reliable can be provided.

### Structure Example 3 of Component 30

The component 30 has a function of receiving selected information Slc from the user and adopting the code snippet CS_1(0) from the suggestion Sug_1, for example (see FIG. 5). The idea input by the user and the suggestion Sug_1 created by the component 21 are displayed on an operation screen of an input/output device connected to the component 30, for example. The user can input the selected information Slc with use of a pointer. The component 30 also has a function of adding the code snippet CS_1(0) after the idea. For example, the component 30 adds the code snippet CS_1(0) after the idea input to the text editor.

Thus, a plurality of code snippets can be provided to the user, for example. Furthermore, one selected from the related code snippets CS_R can be added after the idea written in the text editor, for example. As a result, a novel data processing system that is highly convenient, useful, or reliable can be provided.

### Structure Example 4 of Component 30

The component 30 has a function of receiving an incomplete code InC from the user and transmitting the incomplete code InC to the component 21 (see FIG. 1). Examples of the incomplete code InC include a sentence (also referred to as a statement) in an incomplete state and a formula in an incomplete state. Furthermore, a snippet in an incomplete state is also the incomplete code InC.

The component 30 has a function of receiving a suggestion Sug_2 from the component 21 and providing the suggestion Sug_2 to the user. For example, by the component 30, the suggestion Sug_2 is additionally written after the incomplete code InC input to the text editor.

### Structure Example 2 of Component 20

The component 20 has a function of receiving the incomplete code InC, generating a code snippet CS_2, and transmitting the code snippet CS_2 to the component 21.

### Structure Example 2 of Subcomponent 21A

The subcomponent 21A has a function of receiving the incomplete code InC and transmitting the incomplete code InC to the component 20 (see FIG. 1).

### Structure Example 2 of Subcomponent 21C

The subcomponent 21C has a function of receiving the code snippet CS_2, creating the suggestion Sug_2, and transmitting the suggestion Sug_2 to the component 30. The suggestion Sug_2 includes the code snippet CS_2 (see FIG. 6).

Thus, the code snippet CS_2 can be generated with use of a large language model LLM, and compensation for the incomplete code InC can be provided. Furthermore, without referring to the design assets, the code snippet CS_2 can be generated with use of a large language model LLM, and compensation for the incomplete code InC can be provided. As a result, a novel data processing system that is highly convenient, useful, or reliable can be provided.

### Structure Example 2 of Data Processing System

The data processing system described in this embodiment includes the component 30, the component 21, and the component 20 (see FIG. 1).

The data processing system of one embodiment of the present invention can be composed of a data processing device having a function of the component 30, a data processing device having a function of the component 21, and a data processing device having a function of the component 20, for example. Note that the number of data processing devices constituting the data processing system of one embodiment of the present invention is one or more. For example, a plurality of data processing devices can be connected to each other using a network 51 to construct the data processing system of one embodiment of the present invention.

When the data processing system of one embodiment of the present invention is constituted with the plurality of data processing devices, loads relating to data processing can be dispersed.

### Structure Example 1 of Data Processing Device

A structure example 1 of the data processing device described in this embodiment can be used as the component 30. The structure example 1 of the data processing device can be referred to as a client computer or the like. For example, a desktop computer can be used as the component 30.

The structure example 1 of the data processing device can receive data input by the user of the data processing system of one embodiment of the present invention. The structure example 1 of the data processing device can provide data output from the data processing system of one embodiment of the present invention to the user.

For example, dedicated application software or a web browser operates. Via either of them, the user of the data processing system of one embodiment of the present invention can access the data processing system. Thus, the user can receive service using the data processing system of one embodiment of the present invention.

### Structure Example 2 of Data Processing Device

A structure example 2 of the data processing device described in this embodiment can be used as the component 21. For example, a workstation, a server computer, or a supercomputer can be used as the component 21.

The structure example 2 of the data processing device preferably has a function of a parallel computer. When the data processing device with the structure example 2 is used as a parallel computer, large-scale computation necessary for artificial intelligence (AI) learning and inference can be performed, for example.

Furthermore, the structure example 2 of the data processing device can execute processing using a natural language processing model with use of AI.

For example, processing using natural language models (natural language processing) such as GPT-3, GPT-3.5, GPT-4 (registered trademark), LaMDA, Llama2, and Codellama can be executed.

### Structure Example 3 of Data Processing Device

A structure example 3 of the data processing device described in this embodiment can be used as the component 20, for example. Note that the component 20 has a larger scale and higher computational capability than the component 21. For example, a large computer such as a server computer or a supercomputer can be used as the component 20.

The structure example 3 of the data processing device preferably has a function of a parallel computer. When the data processing device with the structure example 3 is used as a parallel computer, large-scale computation necessary for AI learning and inference can be performed, for example.

Furthermore, the structure example 3 of the data processing device can execute processing using a natural language processing model with use of AI. In particular, the structure example 3 of the data processing device can execute processing using a general-purpose language processing model capable of performing a variety of natural language processing tasks. For example, the structure example 3 of the data processing device can execute processing using a natural language model such as GPT-3, GPT-3.5, GPT-4 (registered trademark), LaMDA, Llama2, or Codellama. In particular, the structure example 3 of the data processing device is preferably capable of executing processing using GPT-4 (registered trademark). For example, processing using a language model that is larger in scale than a conventional natural language model can achieve more natural text generation, interaction, or the like.

Note that a service provider using the data processing system of one embodiment of the present invention does not necessarily have its own structure example 3 of the data processing device. For example, a service provider can utilize part of the service that another company or the like provides using the structure example 3 of the data processing device.

### Structure Example of Network 51

The network 51 that can be used for the data processing system of one embodiment of the present invention can connect the plurality of data processing devices to each other. Thus, the plurality of data processing devices connected to each other can transmit and receive data to and from each other. Furthermore, loads of the data processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the data processing system of one embodiment of the present invention can provide service using the data processing method of one embodiment of the present invention via the network 51, for example.

Note that in the case where the data processing system of one embodiment of the present invention is constructed in a local network, the possibility of leakage of confidential information can be lower than that in the case of using the Internet, for example.

### Structure Example 4 of Data Processing Device

The data processing device that can be used for the data processing system of one embodiment of the present invention includes, for example, an input unit 110, a storage unit 120, a processing unit 130, an output unit 140, and a transmission path 150 (see FIG. 7).

Although the block diagram in drawings attached to this specification illustrates components classified by their functions in independent blocks, it is difficult to classify actual components by their functions completely, and one component can have a plurality of functions. For example, part of the processing unit 130 functions as the input unit 110 in some cases. In addition, one function can be involved in a plurality of components. For example, processing executed by the processing unit 130 may be executed in different servers depending on processing content.

### [Input Unit 110]

The input unit 110 can receive data from the outside of the data processing device. For example, the input unit 110 receives data via the network 51. Specifically, a device such as a personal computer having a communication port and a communication function can be used for the input unit 110.

The input unit 110 supplies the received data to one or both of the storage unit 120 and the processing unit 130 via the transmission path 150.

### [Storage Unit 120]

The storage unit 120 has a function of storing a program to be executed by the processing unit 130. The storage unit 120 can also have a function of storing data generated by the processing unit 130 (e.g., an arithmetic operation result, an analysis result, or an inference result), data received by the input unit 110, and the like.

The storage unit 120 can include a database. The data processing device can include a database in addition to the storage unit 120. The data processing device can have a function of extracting data from a database outside the storage unit 120, the data processing device, or the data processing system. Alternatively, the data processing device can have a function of extracting data from both of its own database and an external database.

One or both of a storage and a file server can be used as the storage unit 120. In addition, a database in which a path of a file stored in the file server is recorded can be used as the storage unit 120.

The storage unit 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 120 can include at least one of a NOSRAM (registered trademark) and a DOSRAM (registered trademark). The storage unit 120 can include a storage media drive. Examples of the storage media drive include a hard disk drive (HDD) and a solid state drive (SSD).

Note that “NOSRAM” is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM can be used as a nonvolatile memory by retaining electric charge corresponding to data in memory cells, using characteristics of extremely low leakage current. In particular, a NOSRAM is capable of reading retained data without destruction (non-destructive reading), and thus is suitable for arithmetic processing in which only data reading operations are repeated many times. A NOSRAM can have large data capacity when stacked in layers, and thus, a semiconductor device in which a NOSRAM is used for a large-scale cache memory, a large-scale main memory, or a large-scale storage memory can have higher performance.

“DOSRAM” is an abbreviation for “dynamic oxide semiconductor RAM” and refers to a RAM including a one-transistor (1T) and one-capacitor (1C) memory cell. A DOSRAM is a DRAM formed using an OS transistor and temporarily stores information sent from the outside. A DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOx) or indium gallium zinc oxide (In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide and gallium tin oxide).

### [Processing Unit 130]

The processing unit 130 has a function of performing processing such as arithmetic operation, analysis, and inference with use of data supplied from one or both of the input unit 110 and the storage unit 120. The processing unit 130 can supply generated data (e.g., an arithmetic operation result, an analysis result, or an inference result) to one or both of the storage unit 120 and the output unit 140.

The processing unit 130 has a function of obtaining data from the storage unit 120. The processing unit 130 can also have a function of storing or registering data in the storage unit 120.

The processing unit 130 can include an arithmetic circuit, for example. The processing unit 130 can include, for example, a central processing unit (CPU). The processing unit 130 can also include a graphics processing unit (GPU). Furthermore, the processing unit 130 can include a neural processing unit/neural network processing unit (NPU).

The processing unit 130 can include a microprocessor such as a digital signal processor (DSP). The microprocessor can be achieved with a programmable logic device (PLD) such as a field programmable gate array (FPGA) or a field programmable analog array (FPAA). The processing unit 130 can also include a quantum processor. With a processor, the processing unit 130 can interpret and execute instructions from various kinds of programs to process various kinds of data and control programs. The programs to be executed by the processor are stored in at least one of the storage unit 120 and a memory region of the processor.

The processing unit 130 can include a main memory. The main memory includes at least one of a volatile memory such as RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 130. An operating system, an application program, a program module, program data, a look-up table, and the like which are stored in the storage unit 120 are loaded into the RAM for execution. The data, program, and program module which are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (Si transistor).

The processing unit 130 preferably includes an OS transistor. Since the OS transistor has an extremely low off-state current, a long data retention period can be ensured with use of the OS transistor as a switch for retaining electric charge (data) that has flowed into a capacitor functioning as a memory element. When at least one of a register and a cache memory included in the processing unit has such a feature, the processing unit can be operated only when needed, and otherwise can be off while data processed immediately before turning off the processing unit is stored in the memory element. In other words, normally-off computing is possible and the power consumption of the data processing system can be reduced.

The data processing device preferably uses AI for at least part of its processing.

In particular, the data processing device preferably uses an artificial neural network (ANN; hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### [Output Unit 140]

The output unit 140 can output at least one of an arithmetic operation result, an analysis result, and an inference result in the processing unit 130 to the outside of the data processing device. For example, the output unit 140 can transmit data via the network 51. Specifically, a device such as a personal computer having a communication port or a communication function can be used for the output unit 140. Furthermore, a device having a communication function may be used as the input unit 110 and the output unit 140.

### [Transmission Path 150]

The transmission path 150 has a function of transmitting data. Data transmission and reception between the input unit 110, the storage unit 120, the processing unit 130, and the output unit 140 can be performed via the transmission path 150. Specifically, an external bus, a LAN or the Internet can be used for the transmission path 150.

Note that this embodiment can be combined with any of the other embodiments in this specification as appropriate.

### Embodiment 2

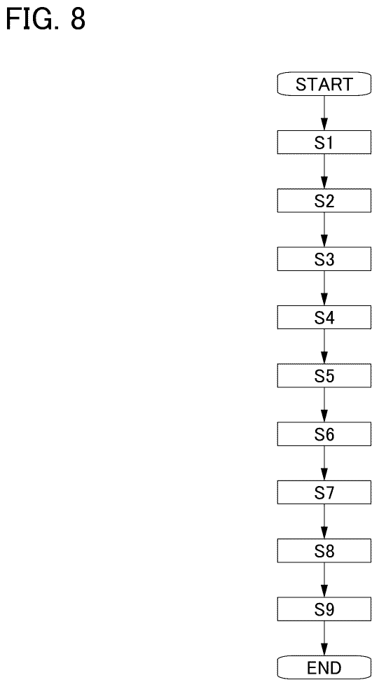

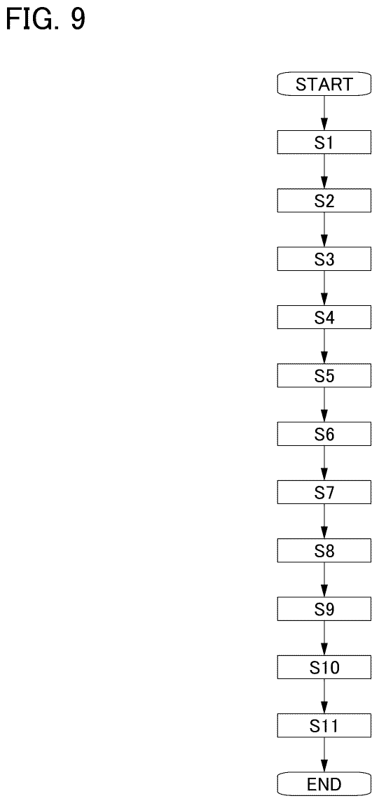

In this embodiment, a data processing method of one embodiment of the present invention will be described with reference to FIG. 8 and FIG. 9.

FIG. 8 shows a data processing method of one embodiment of the present invention.

FIG. 9 shows another data processing method of one embodiment of the present invention, which is different from the data processing method described with reference to FIG. 8.

### Example 1 of Data Processing Method

The data processing method of one embodiment of the present invention includes Steps S1 to S9 (see FIG. 8).

### [Step S1]

In Step S1, the component 30 receives the idea from a user and transmits the idea to the component 21. The user can input the idea to a text editor, for example. Specifically, the idea can be input, in a predetermined format, to a code that is being created in a hardware description language. For example, the input character string in the comment text format exemplified in Embodiment 1 can be used as the idea.

### [Step S2]

In Step S2, the component 21 receives the idea and creates the prompt Pt_1. The prompt Pt_1 includes the idea and the instruction g1 ( ) for generating the code snippet CS_0 from the idea. For example, the sentence exemplified in Embodiment 1 can be used as the prompt Pt_1.

### [Step S3]

In Step S3, the component 21 transmits the prompt Pt_1 to the component 20.

### [Step S4]

In Step S4, the component 20 receives the prompt Pt_1 and generates the code snippet CS_0 with use of the large language model LLM. For example, the large language model LLM enables the generation of a segment of the code exemplified in Embodiment 1.

Note that the large language model LLM has a function of generating the code snippet CS_0 in accordance with the prompt Pt_1.

### [Step S5]

In Step S5, the component 20 transmits the code snippet CS_0 to the component 21.

### [Step S6]

In Step S6, the component 21 receives the code snippet CS_0 and creates the query Que. Note that the query Que includes the code snippet CS_0.

### [Step S7]

In Step S7, the component 21 searches out the related snippet CS_R with use of the search engine SE.

The component 21 includes the search engine SE and the index INDX.

The search engine SE has a function of searching out the related code snippet CS_R related to the query Que with use of the index INDX and a function of calculating the similarity DoS_1.

The index INDX includes the document Doc_1, and the document Doc_1 includes the code snippet CS_1(0). The related code snippet CS_R includes the code snippet CS_1(0).

The similarity DoS_1(0) represents the degree of correlation between the code snippet CS_0 and the code snippet CS_1(0).

### [Step S8]

In Step S8, the component 21 creates the suggestion Sug_1 and transmits the suggestion Sug_1 to the component 30. Note that the suggestion Sug_1 includes the related code snippet CS_R.

### [Step S9]

In Step S9, the component 30 receives and provides the suggestion Sug_1.

Accordingly, the code snippet CS_0 can be generated from the idea written in a natural language in the text editor by the user, for example. Furthermore, a composition of one or both of a function and specifications of an integrated circuit written in a natural language by the user can be used for the idea, for example. Furthermore, on the basis of the idea, the code snippet CS_0 where a register transfer level of the integrated circuit is written in a hardware description language can be generated, for example.

Moreover, the code snippet CS_1(0) related to the code snippet CS_0 generated from the idea can be searched out with use of the index INDX. In addition, design assets can be stored in the index INDX, for example. The code snippet CS_1(0) related to the code snippet CS_0 can be searched out from the design assets, for example.

Furthermore, one or more code snippets related to the code snippet CS_0 can be used as the related code snippet CS_R. The related code snippet CS_R can be written in the suggestion Sug_1 and provided to the user. In addition, a code snippet that has been assessed can be searched out from the design assets and provided for the user. As a result, a novel data processing method that is highly convenient, useful, or reliable can be provided.

### Example 2 of Data Processing Method

Another data processing method of one embodiment of the present invention also includes Steps S1 to S9 (see FIG. 8); however, <Example 2 of data processing method> is different from <Example 1 of data processing method> in that the component 30 receives the design information DI_0 as well as the idea in Step S6 and that the design information DI_0 as well as the code snippet CS_0 are used for the query Que. Different portions are described in detail here, and the above description is referred to for portions using steps similar to the above.

### [Step S1]

In Step S1, the component 30 receives the design information DI_0 and the idea from the user and transmits them to the component 21.

### [Step S6]

In Step S6, the component 21 receives the design information DI_0 and the code snippet CS_0 and creates the query Que. Note that the query Que includes the design information DI_0 and the code snippet CS_0.

Thus, the design information DI_0 can be included in conditions for searching out the related code snippet CS_R with use of the index INDX. In addition, an operating frequency can be included in the conditions for searching out the related code snippet CS_R with use of the index INDX, for example. Furthermore, power consumption can be included in the conditions for searching out the related code snippet CS_R with use of the index INDX, for example. Furthermore, including the design information DI_0 in the searching conditions enables extremely valuable information to be extracted from the past technological assets. As a result, a novel data processing system that is highly convenient, useful, or reliable can be provided.

### Example 3 of Data Processing Method

Another data processing method of one embodiment of the present invention includes Steps S1 to S11 (see FIG. 9). Note that <Example 3 of data processing method> is different from <Example 1 of data processing method> or <Example 2 of data processing method> in that Steps S10 and S11 are included. Different portions are described in detail here, and the above description is referred to for portions using steps similar to the above.

### [Step S10]

In Step S10 following Step S9, the component 30 receives the selected information Slc from the user and adopts the code snippet CS_1(0) from the suggestion Sug_1. For example, the user can input the selected information with use of a pointer.

### [Step S11]

In Step S11, the component 30 adds the code snippet CS_1(0) after the idea. For example, the component 30 adds the code snippet CS_1(0) after the idea input to the text editor.

Thus, a plurality of code snippets can be provided to the user, for example. Furthermore, one selected from the related code snippets CS_R can be added after the idea written in the text editor, for example. As a result, a novel data processing system that is highly convenient, useful, or reliable can be provided.

Note that this embodiment can be combined with any of the other embodiments in this specification as appropriate.

This application is based on Japanese Patent Application Serial No. 2024-017712 filed with Japan Patent Office on Feb. 8, 2024, the entire contents of which are hereby incorporated by reference.

What is claimed is:

1. A data processing system comprising:
a first component:
a second component; and
a third component,
wherein the first component is configured to receive an idea and to transmit the idea to the third component,
wherein the first component is configured to receive a first suggestion and to provide the first suggestion,
wherein the second component is configured to receive a prompt, to perform processing with a large language model, and to transmit a first code snippet to the third component,
wherein the large language model is configured to generate the first code snippet in accordance with the prompt,
wherein the third component comprises a first subcomponent, a second subcomponent, and a third subcomponent,
wherein the first subcomponent is configured to receive the idea, to create the prompt, and to transmit the prompt to the second component,
wherein the prompt comprises the idea and an instruction for generating the first code snippet from the idea,
wherein the second subcomponent is configured to receive the first code snippet and to create a query,
wherein the second subcomponent comprises a search engine and an index,
wherein the query comprises the first code snippet,
wherein the search engine is configured to search out a related code snippet related to the query with use of the index,
wherein the search engine is configured to calculate a similarity,
wherein the index comprises a document,
wherein the document comprises a second code snippet,
wherein the related code snippet comprises the second code snippet,
wherein the similarity represents a degree of correlation between the first code snippet and the second code snippet,
wherein the third subcomponent is configured to receive the related code snippet, to create the first suggestion, and to transmit the first suggestion to the first component, and
wherein the first suggestion comprises the related code snippet.

2. The data processing system according to claim 1,
wherein the first component is configured to receive design information and to transmit the design information to the third component,
wherein the second subcomponent is configured to receive the design information and the first code snippet and to create the query, and
wherein the query comprises the design information and the first code snippet.

3. The data processing system according to claim 1,
wherein the first component is configured to receive selected information and to adopt the second code snippet from the first suggestion, and
wherein the first component is configured to add the second code snippet after the idea.

4. The data processing system according to claim 1,
wherein the first component is configured to receive an incomplete code and to transmit the incomplete code to the third component,
wherein the first component is configured to receive a second suggestion and to provide the second suggestion,
wherein the second component is configured to receive the incomplete code, to generate a third code snippet, and to transmit the third code snippet to the third component,
wherein the first subcomponent is configured to receive the incomplete code and to transmit the incomplete code to the second component,
wherein the third subcomponent is configured to receive the third code snippet, to create the second suggestion, and to transmit the second suggestion to the first component, and
wherein the second suggestion comprises the third code snippet.

5. A data processing method comprising a first step, a second step, a third step, a fourth step, a fifth step, a sixth step, a seventh step, an eighth step, and a ninth step,
wherein in the first step, a first component receives an idea and transmits the idea to a second component,
wherein in the second step, the second component receives the idea and creates a prompt,
wherein the prompt comprises the idea and an instruction for generating a first code snippet from the idea,
wherein in the third step, the second component transmits the prompt to a third component,
wherein in the fourth step, the third component receives the prompt and creates the first code snippet with use of a large language model,
wherein the large language model is configured to generate the first code snippet in accordance with the prompt,
wherein in the fifth step, the third component transmits the first code snippet to the second component,
wherein in the sixth step, the second component receives the first code snippet and creates a query,
wherein the query comprises the first code snippet,
wherein in the seventh step, the second component searched out a related code snippet with use of a search engine,
wherein the second component comprises the search engine and an index,
wherein the search engine is configured to search out the related code snippet related to the query with use of the index and configured to calculate a similarity,
wherein the index comprises a document,
wherein the document comprises a second code snippet,
wherein the related code snippet comprises the second code snippet,
wherein the similarity represents a degree of correlation between the first code snippet and the second code snippet,
wherein in the eighth step, the second component creates a suggestion and transmits the suggestion to the first component,
wherein the suggestion comprises the related code snippet, and
wherein in the ninth step, the first component receives the suggestion and provides the suggestion.

6. The data processing method according to claim 5,
wherein in the first step, the first component receives design information and the idea and transmits the design information and the idea to the second component,
wherein in the sixth step, the second component receives the design information and the first code snippet and creates the query, and
wherein the query comprises the design information and the first code snippet.

7. The data processing method according to claim 5, further comprising a tenth step and an eleventh step,
wherein in the eleventh step following the ninth step, the first component receives selected information and adopts the second code snippet from the suggestion, and
wherein in the eleventh step, the first component adds the second code snippet after the idea.

8. A data processing system comprising:
a first component:
a second component; and
a third component,
wherein the first component is configured to receive an idea and to transmit the idea to the third component,
wherein the first component is configured to receive a first suggestion and to provide the first suggestion,
wherein the second component is configured to receive a prompt, to perform processing with a large language model, and to transmit a first code snippet to the third component,
wherein the large language model is configured to generate the first code snippet in accordance with the prompt,
wherein the third component comprises a search engine and an index,
wherein the third component is configured to receive the idea, to create the prompt, and to transmit the prompt to the second component,
wherein the prompt comprises the idea and an instruction for generating the first code snippet from the idea,
wherein the third component is configured to receive the first code snippet and to create a query,
wherein the query comprises the first code snippet,
wherein the search engine is configured to search out a related code snippet related to the query with use of the index,
wherein the search engine is configured to calculate a similarity,
wherein the index comprises a document,
wherein the document comprises a second code snippet,
wherein the related code snippet comprises the second code snippet,
wherein the similarity represents a degree of correlation between the first code snippet and the second code snippet,
wherein the third component is configured to receive the related code snippet, to create the first suggestion, and to transmit the first suggestion to the first component, and
wherein the first suggestion comprises the related code snippet.

9. The data processing system according to claim 8,
wherein the first component is configured to receive design information and to transmit the design information to the third component,
wherein the third component is configured to receive the design information and the first code snippet and to create the query, and
wherein the query comprises the design information and the first code snippet.

10. The data processing system according to claim 8,
wherein the first component is configured to receive selected information and to adopt the second code snippet from the first suggestion, and
wherein the first component is configured to add the second code snippet after the idea.

11. The data processing system according to claim 8,
wherein the first component is configured to receive an incomplete code and to transmit the incomplete code to the third component,
wherein the first component is configured to receive a second suggestion and to provide the second suggestion,
wherein the second component is configured to receive the incomplete code, to generate a third code snippet, and to transmit the third code snippet to the third component,
wherein the third component is configured to receive the incomplete code and to transmit the incomplete code to the second component,
wherein the third component is configured to receive the third code snippet, to create the second suggestion, and to transmit the second suggestion to the first component, and
wherein the second suggestion comprises the third code snippet.
